(19) United States
(12) Patent Application Publication
(10) Pub. No.: US 2026/0371365 A1
(43) Pub. Date: Nov. 19, 2026

(54) METHOD AND DEVICE FOR CONFIGURING RESOURCE POOL, AND COMPUTER-READABLE STORAGE MEDIUM

(71) Applicant: Beijing Xiaomi Mobile Software Co., Ltd., Beijing (CN)

(72) Inventors: Wensu ZHAO, Beijing (CN); Qun ZHAO, Beijing (CN)

(73) Assignee: Beijing Xiaomi Mobile Software Co., Ltd., Beijing (CN)

(21) Appl. No.: 19/148,243

(22) PCT Filed: Jan. 16, 2023
(86) PCT No.: PCT/CN2023/072429

§ 371 Date: Jul. 15, 2025

(51) Int. Cl. H04W 72/25; H04L 5/00; H04L 27/26

(52) U.S. Cl. CPC H04W 72/25; H04L 5/0094; H04L 27/26025

(57) ABSTRACT

The present disclosure relates to the technical field of communications. Provided are a resource pool configuration method, and an apparatus and a computer-readable storage medium. The method comprises: determining that K candidate starting symbols are supported in one slot in a sidelink resource pool; and setting the maximum number of sub-channels included in the sidelink resource pool to not exceed floor (N/K), wherein N and K are both positive integers. By means of the method provided in the present disclosure, the maximum number of sub-channels or RB sets included in a sidelink resource pool is set, such that the number of sub-channels in the sidelink resource pool is reduced, thereby reducing the number of instances of PSCCH blind detection performed by means of a terminal device, and reducing the energy consumption of a receiving terminal device.

### CROSS-REFERENCE TO RELATED APPLICATION

The present application is a U.S. National Stage of International Application No. PCT/CN2023/072429, filed on Jan. 16, 2023, the contents of all of which are incorporated herein by reference in their entirety for all purposes.

### BACKGROUND OF THE INVENTION

In a communication system, the demand for communication capabilities keeps increasing as wireless communication continuously evolves. In an unlicensed frequency band of a sidelink (SL), a physical sidelink control channel (PSCCH) in the sidelink is transmitted in one sub-channel and this sub-channel is located in a lowest sub-channel of a lowest resource block (RB) set of a corresponding physical sidelink shared channel (PSSCH). A receiving user equipment determines a sub-channel where the PSSCH is located by blindly detecting all sub-channels in an entire resource pool at a position of symbol automatic gain control (AGC) of one slot, and thus determines a frequency domain position of the PSCCH. In resource pool configuration of Release 16 (R16) or Release 17 (R17), one resource pool may contain up to 27 sub-channels.

### SUMMARY OF THE INVENTION

The present disclosure relates to the technical field of communication, and particularly relates to a method and a device for configuring a resource pool, and a computer-readable storage medium.

According to an aspect of embodiments of the present disclosure, a method for configuring a resource pool is provided. The method is applied to an unlicensed frequency band of a sidelink and performed by a network device. The method includes:
determining that K candidate starting symbols are supported in one slot in a sidelink resource pool; and configuring a maximum number of sub-channels included in the sidelink resource pool to not exceed floor (N/K), where N and K are positive integers.

According to another aspect of the embodiments of the present disclosure, a method for configuring a resource pool is provided. The method is applied to an unlicensed frequency band of a sidelink and performed by a network device. The method includes:
determining that K candidate starting symbols are supported in one slot in a sidelink resource pool; and configuring a maximum number of resource block (RB) sets included in the sidelink resource pool to not exceed floor (N/(M*K)), where N and K are positive integers, and M is a number of sub-channels included in one RB set.

According to another aspect of the embodiments of the present disclosure, a network device is provided. The network device is applied to an unlicensed frequency band of a sidelink. The network device includes:
a processing module configured to determine that K candidate starting symbols are supported in one slot in a sidelink resource pool; and configure a maximum number of sub-channels included in the sidelink resource pool to not exceed floor (N/K), where N and K are positive integers.

According to another aspect of the embodiments of the present disclosure, a network device is provided. The network device is applied to an unlicensed frequency band of a sidelink. The network device includes:
a processing module configured to determine that K candidate starting symbols are supported in one slot in a sidelink resource pool; and configure a maximum number of resource block (RB) sets included in the sidelink resource pool to not exceed floor (N/(M*K)), where N and K are positive integers, and M is a number of sub-channels included in one RB set.

According to another aspect of the embodiments of the present disclosure, a communication device is provided. The communication device includes one or more processors and a memory. The memory stores a computer program. The one or more processors, when executing the computer program, implement the method provided in the above aspect of embodiments.

According to another aspect of the embodiments of the present disclosure, a communication device is provided. The communication device includes: one or more processors and an interface circuit.

The interface circuit is configured to receive code instructions and transmit the code instructions to the one or more processors; and
the one or more processors, when running the code instructions, are collectively configured to perform one method provided in the above aspects of embodiments.

According to another aspect of the examples of the present disclosure, a non-transitory computer-readable storage medium is provided. The non-transitory computer-readable storage medium is configured to store instructions. The instructions, when executed by one or more processors of a communication device, cause the communication device to perform one method provided in the above aspects of embodiments.

### BRIEF DESCRIPTION OF DRAWINGS

The above and/or additional aspects and advantages of the present disclosure will become apparent and readily appreciated from the following description of examples in conjunction with the accompanying drawings.

FIG. 1 is a schematic flowchart of a method for configuring a resource pool according to an embodiment of the present disclosure.

FIG. 2 is a schematic flowchart of a method for configuring a resource pool according to another embodiment of the present disclosure.

FIG. 3 is a schematic flowchart of a method for configuring a resource pool according to another embodiment of the present disclosure.

FIG. 4 is a schematic flowchart of a method for configuring a resource pool according to another embodiment of the present disclosure.

FIG. 5 is a schematic flowchart of a resource pool configuration method according to another embodiment of the present disclosure.

FIG. 6 is a schematic flowchart of a method for configuring a resource pool according to another embodiment of the present disclosure.

FIG. 7 is a schematic flowchart of a resource pool configuration method according to another embodiment of the present disclosure.

FIG. 8 is a schematic flowchart of a resource pool configuration method according to another embodiment of the present disclosure.

FIG. 9 is a schematic structural diagram of a network device according to an embodiment of the present disclosure.

FIG. 10 is a schematic structural diagram of a network device according to another embodiment of the present disclosure.

FIG. 11 is a block diagram of a network device according to an embodiment of the present disclosure.

### DETAILED DESCRIPTION OF THE INVENTION

Description will be made in detail to examples in the present disclosure, and their instances are illustrated in the accompanying drawings. When the following description relates to the accompanying drawings, the same numbers in different accompanying drawings denote the same or similar elements, unless indicated otherwise. The implementations described in the examples below do not denote all implementations consistent with the embodiments of the present disclosure. On the contrary, they are merely instances of devices and methods consistent with some aspects of the embodiments of the present disclosure as described in detail in the appended claims.

The term used in the embodiments of the present disclosure is for the purpose of describing particular embodiments merely and is not intended to limit the embodiments of the present disclosure. As used in the embodiments and the appended claims of the present disclosure, singular forms “a,” “an” and “the” are intended to include plural forms as well, unless otherwise clearly indicated in the context. It is also to be understood that the term “and/or” used in the present disclosure means and encompasses one or any or all possible combinations of a plurality of associated items listed.

It is to be understood that while the terms first, second, third, etc. may be employed in the embodiments of the present disclosure to describe various information, these pieces of information is not to be limited to this. These terms are merely used to distinguish the same type of information from each other. For example, first information may also be referred to as second information, and similarly, second information may also be referred to as first information, without departing from the scope of the examples of the present disclosure. The word “if” as used in the present disclosure may be construed to mean “at the time of,” “when” or “in response to determining”, depending on the context.

A network element or a network function involved in the embodiments of the present disclosure may be implemented by independent hardware devices, or may be implemented by software in hardware devices, which is not limited in the embodiments of the present disclosure.

In the unlicensed frequency band of the sidelink, two candidate starting symbols (that is, positions of two AGCs) may be supported in one slot, so a transmitting user equipment may access a channel at a position of a second candidate starting symbol to start transmitting data. Then, the receiving user equipment needs to blindly detect the PSCCH one by one on the sub-channels in the resource pool at the positions of the two candidate starting symbols. Accordingly, a number of blind detections will be greatly increased, a complexity of the blind detection by the receiving user equipment will be increased, and a maximum number of blind detections supported by the receiving user equipment may be exceeded, resulting in high energy consumption of the receiving user equipment.

With reference to the following accompanying drawings, a method and a device for configuring a resource pool, and a computer-readable storage medium provided in the embodiments of the present disclosure are described in detail.

FIG. 1 is a schematic flowchart of a method for configuring a resource pool according to an embodiment of the present disclosure. The method is performed by a network device. As shown in FIG. 1, the method may include steps 101 to 102.
Step 101 includes determining that K candidate starting symbols are supported in one slot in a sidelink resource pool.
Step 102 includes configuring a maximum number of sub-channels included in the sidelink resource pool to not exceed floor (N/K), where N and K are positive integers.

In an embodiment of the present disclosure, the method may be applied to an unlicensed frequency band of a sidelink.

In an embodiment of the present disclosure, floor indicates a round-down function. For example, the floor (N/K) may indicate a round-down function for N/K. For example, the floor (N/K) may be a largest integer not greater than N/K.

Furthermore, in an embodiment of the present disclosure, one candidate starting symbol is supported in one slot, and floor (N) is equal to N.

In an embodiment of the present disclosure, it is determined that one candidate starting symbol is supported in one slot in the sidelink resource pool. The maximum number of the sub-channels included in the sidelink resource pool is configured to not exceed the floor (N), where the floor (N) is equal to N.

In an embodiment of the present disclosure, one candidate starting symbol is supported in one slot. The maximum number of the sub-channels included in the sidelink resource pool may be configured to be equal to N.

In an embodiment of the present disclosure, one candidate starting symbol is supported in one slot. The maximum number of the sub-channels included in the sidelink resource pool may be configured to be less than N alternatively.

Furthermore, in an embodiment of the present disclosure, two candidate starting symbols are supported in one slot. The maximum number of the sub-channels does not exceed floor (N/2).

In an embodiment of the present disclosure, it is determined that the two candidate starting symbols are supported in one slot in the sidelink resource pool. The maximum number of the sub-channels included in the sidelink resource pool is configured to not exceed the floor (N/2).

Further, in an embodiment of the present disclosure, one candidate starting symbol is supported in one slot. That is, in a case where a value of K is 1, the maximum number of the sub-channels included in the sidelink resource pool may be configured to be equal to N.

In an embodiment of the present disclosure, N is a maximum number of blind detections of physical sidelink control channel (PSCCH) supported by a user equipment in one slot.

In an embodiment of the present disclosure, N is a maximum number of blind detections of physical downlink control channel (PDCCH) supported by the user equipment in one slot.

In an embodiment of the present disclosure, the maximum number of the blind detections of the PDCCH supported by the user equipment in one slot, that is, N, is equal to 44, 36, 22, and 20 for 15 khz, 30 khz, 60 khz, and 120 khz respectively. A value of N is the maximum number of the blind detections of the PDCCH supported by the user equipment in one slot. Different sub-carrier spacing corresponds to different values of N.

Further, in an embodiment of the present disclosure, for sub-carrier spacing of 15 khz, the value of N may be, for example, 44. For sub-carrier spacing of 30 khz, the value of N may be, for example, 36. For sub-carrier spacing of 60 khz, the value of N may be, for example, 22. For a sub-carrier spacing of 120 khz, the value of N may be, for example, 20.

In an embodiment of the present disclosure, the method further includes:
determining N and K according to the sub-carrier spacing.

In an embodiment of the present disclosure, a value of K may be, for example, 1, or a value of K may be, for example, 2.

In an embodiment of the present disclosure, for the sub-carrier spacing of 15 khz, the value of N may be, for example, 44, the value of K may be, for example, 1, and the maximum number of the sub-channels included in the sidelink resource pool is configured to not exceed 44. For the sub-carrier spacing of 30 khz, the value of N may be, for example, 36, the value of K may be, for example, 1, and the maximum number of the sub-channels included in the sidelink resource pool is configured to not exceed 36. For the sub-carrier spacing of 60 khz, the value of N may be, for example, 22, the value of K may be, for example, 1, and the maximum number of the sub-channels included in the sidelink resource pool is configured to not exceed 22. For the sub-carrier spacing of 120 khz, the value of N may be, for example, 20, the value of K may be, for example, 1, and the maximum number of the sub-channels included in the sidelink resource pool is configured to not exceed 20.

In an embodiment of the present disclosure, for the sub-carrier spacing of 15 khz, the value of N may be, for example, 44, the value of K may be, for example, 2, and the maximum number of the sub-channels included in the sidelink resource pool is configured to not exceed 44/2=22. For the sub-carrier spacing of 30 khz, the value of N may be, for example, 36, the value of K may be, for example, 2, and the maximum number of the sub-channels included in the sidelink resource pool is configured to not exceed 36/2=18. For the sub-carrier spacing of 60 khz, the value of N may be, for example, 22, the value of K may be, for example, 2, and the maximum number of the sub-channels included in the sidelink resource pool is configured to not exceed 22/2=11. For the sub-carrier spacing of 120 khz, the value of N may be, for example, 20, the value of K may be, for example, 2, and the maximum number of the sub-channels included in the sidelink resource pool is configured to not exceed 20/2=10.

According to the embodiments of the present disclosure, it is determined that K candidate starting symbols are supported in one slot in the sidelink resource pool. The maximum number of the sub-channels included in the sidelink resource pool is configured to not exceed the floor (N/K), where N and K are positive integers. In the embodiments of the present disclosure, a configuration mechanism for the resource pool may be provided, and the maximum number of the sub-channels included in the sidelink resource pool may be configured, such that the number of the sub-channels in the resource pool is reduced. Thus complexity of the blind detection by a receiving user equipment is reduced. Further, a situation that the receiving user equipment cannot receive data in a case that a number of the blind detections exceeds the maximum number of the blind detections by the receiving user equipment is reduced. Consequently, the energy consumption of the receiving user equipment may be reduced. The present disclosure provides a method for “configuring a resource pool”. The maximum number of the sub-channels included in the sidelink resource pool is configured to not exceed the floor (N/K), such that the number of the sub-channels in the sidelink resource pool may be reduced, then the number of the blind detections of the PSCCH by the receiving user equipment may be reduced, and the energy consumption of the receiving user equipment may be reduced.

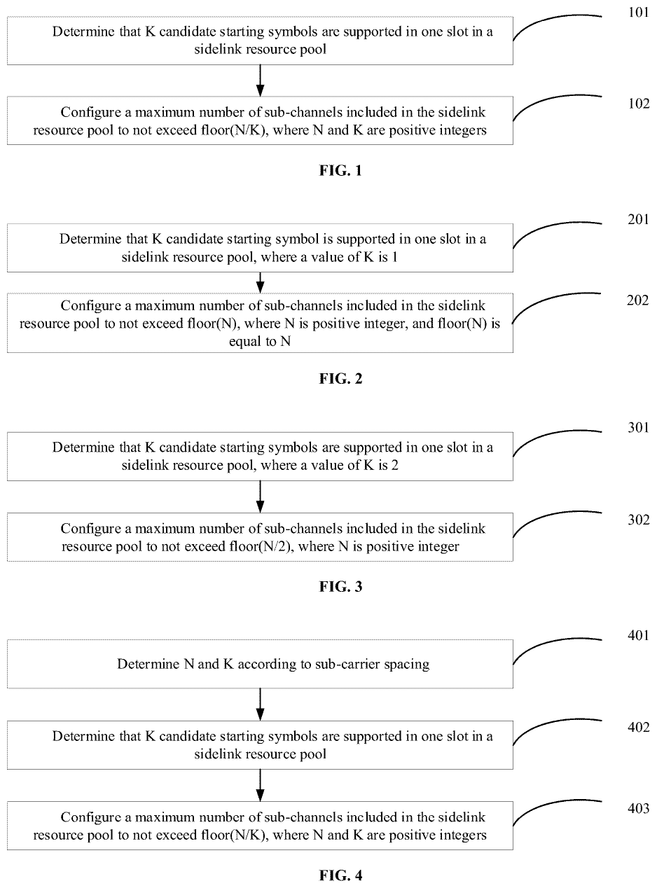

FIG. 2 is a schematic flowchart of a method for configuring a resource pool according to an embodiment of the present disclosure. The method is performed by a network device. As shown in FIG. 2, the method may include steps 201 to 202.

Step 201 includes determining that K candidate starting symbol is supported in one slot in a sidelink resource pool, where a value of K is 1.

Step 202 includes configuring a maximum number of sub-channels included in the sidelink resource pool to not exceed floor (N), where N is a positive integer, and floor (N) is equal to N.

In an embodiment of the present disclosure, description of steps 201 to 202 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

In an embodiment of the present disclosure, a value of K may be, for example, 1. For example, a number of the candidate starting symbol supported in one slot may be 1.

Furthermore, in an embodiment of the present disclosure, one candidate starting symbol is supported in one slot, and the floor (N) is equal to N.

In an embodiment of the present disclosure, one candidate starting symbol is supported in one slot. The maximum number of the sub-channels included in the sidelink resource pool may be configured to be equal to N.

In an embodiment of the present disclosure, one candidate starting symbol is supported in one slot. The maximum number of the sub-channels included in the sidelink resource pool may be configured to be less than N, alternatively.

In an embodiment of the present disclosure, for the sub-carrier spacing of 15 khz, the value of N may be, for example, 44, the value of K may be, for example, 1, and the maximum number of the sub-channels included in the sidelink resource pool is configured to not exceed 44. For the sub-carrier spacing of 30 khz, the value of N may be, for example, 36, the value of K may be, for example, 1, and the maximum number of the sub-channels included in the sidelink resource pool is configured to not exceed 36. For the sub-carrier spacing of 60 khz, the value of N may be, for example, 22, the value of K may be, for example, 1, and the maximum number of the sub-channels included in the sidelink resource pool is configured to not exceed 22. For the sub-carrier spacing of 120 khz, the value of N may be, for example, 20, the value of K may be, for example, 1, and the maximum number of the sub-channels included in the sidelink resource pool is configured to not exceed 20.

According to the embodiments of the present disclosure, it is determined that one candidate starting symbol is supported in one slot in the sidelink resource pool. The maximum number of the sub-channels included in the sidelink resource pool is configured to not exceed the floor (N), where N is a positive integer, and floor (N) is equal to N. In the embodiments of the present disclosure, a configuration mechanism for the resource pool may be provided, and the maximum number of the sub-channels included in the sidelink resource pool may be configured, such that the number of the sub-channels in the resource pool is reduced. Thus complexity of the blind detection by a receiving user equipment is reduced. Further, a situation that the receiving user equipment cannot receive data in a case that a number of the blind detections exceeds the maximum number of the blind detections by the receiving user equipment is reduced. Consequently, the energy consumption of the receiving user equipment may be reduced. The embodiments of the present disclosure disclose a solution for configuring the maximum number of the sub-channels included in the sidelink resource pool in a case where the number of the candidate starting symbols supported in one slot is one. The present disclosure provides a method for “configuring a resource pool”. The maximum number of the sub-channels included in the sidelink resource pool is configured to not exceed floor (N), such that the number of the sub-channels in the sidelink resource pool may be reduced, then the number of the blind detections of the PSCCH by the receiving user equipment may be reduced, and the energy consumption of the receiving user equipment may be reduced.

FIG. 3 is a schematic flowchart of a method for configuring a resource pool according to an embodiment of the present disclosure. The method is performed by a network device. As shown in FIG. 3, the method may include steps 301 to 302.

Step 301 includes determining that K candidate starting symbols are supported in one slot in a sidelink resource pool, where a value of K is 2.

Step 302 includes configuring a maximum number of sub-channels included in the sidelink resource pool to not exceed floor (N/2), where N is positive integer.

In an embodiment of the present disclosure, description of steps 301 to 302 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

In an embodiment of the present disclosure, a value of K may be, for example, 2. For example, a number of the candidate starting symbol supported in one slot may be 2.

Furthermore, in an embodiment of the present disclosure, the two candidate starting symbols are supported in one slot. The maximum number of the sub-channels does not exceed the floor (N/2).

In an embodiment of the present disclosure, for the sub-carrier spacing of 15 khz, the value of N may be, for example, 44, the value of K may be, for example, 2, and the maximum number of the sub-channels included in the sidelink resource pool is configured to not exceed 44/2=22. For the sub-carrier spacing of 30 khz, the value of N may be, for example, 36, the value of K may be, for example, 2, and the maximum number of the sub-channels included in the sidelink resource pool is configured to not exceed 36/2=18. For the sub-carrier spacing of 60 khz, the value of N may be, for example, 22, the value of K may be, for example, 2, and the maximum number of the sub-channels included in the sidelink resource pool is configured to not exceed 22/2=11. For the sub-carrier spacing of 120 khz, the value of N may be, for example, 20, the value of K may be, for example, 2, and the maximum number of the sub-channels included in the sidelink resource pool is configured to not exceed 20/2=10.

According to the embodiments of the present disclosure, it is determined that the K candidate starting symbols are supported in one slot in the sidelink resource pool. The maximum number of the sub-channels included in the sidelink resource pool is configured to not exceed the floor (N/2), where N and K are positive integers. In the embodiments of the present disclosure, a configuration mechanism for the resource pool may be provided, and the maximum number of the sub-channels included in the sidelink resource pool may be configured, such that the number of the sub-channels in the resource pool is limited. Thus complexity of the blind detection by a receiving user equipment is reduced. Further, a situation that the receiving user equipment cannot receive data in a case that a number of the blind detections exceeds the maximum number of blind detections by the receiving user equipment is reduced. Consequently, the energy consumption of the receiving user equipment may be reduced. The embodiments of the present disclosure disclose a solution for configuring the maximum number of the sub-channels included in the sidelink resource pool in a case where the number of the candidate starting symbols supported in one slot is two. The present disclosure provides a method for “configuring a resource pool”. The maximum number of the sub-channels included in the sidelink resource pool is configured to not exceed floor (N/2), such that the number of the sub-channels in the sidelink resource pool may be reduced, then the number of the blind detections of the PSCCH by the receiving user equipment may be reduced, and the energy consumption of the receiving user equipment may be reduced.

FIG. 4 is a schematic flowchart of a method for configuring a resource pool according to an embodiment of the present disclosure. The method is performed by a network device. As shown in FIG. 4, the method may include steps 401 to 403.

Step 401 includes determining N and K according to sub-carrier spacing.

Step 402 includes determining that K candidate starting symbols are supported in one slot in a sidelink resource pool.

Step 403 includes configuring a maximum number of sub-channels included in the sidelink resource pool to not exceed floor (N/K), where N and K are positive integers.

In an embodiment of the present disclosure, the description of steps 401 to 403 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

In an embodiment of the present disclosure, for sub-carrier spacing of 15 khz, the value of N may be, for example, 44. For sub-carrier spacing of 30 khz, the value of N may be, for example, 36. For sub-carrier spacing of 60 khz, the value of N may be, for example, 22. For a sub-carrier spacing of 120 khz, the value of N may be, for example, 20.

In an embodiment of the present disclosure, for the sub-carrier spacing of 15 khz, the value of N may be, for example, 44, the value of K may be, for example, 1, and the maximum number of the sub-channels included in the sidelink resource pool is configured to not exceed 44. For the sub-carrier spacing of 30 khz, the value of N may be, for example, 36, the value of K may be, for example, 1, and the maximum number of the sub-channels included in the sidelink resource pool is configured to not exceed 36. For the sub-carrier spacing of 60 khz, the value of N may be, for example, 22, the value of K may be, for example, 1, and the maximum number of the sub-channels included in the sidelink resource pool is configured to not exceed 22. For the sub-carrier spacing of 120 khz, the value of N may be, for example, 20, the value of K may be, for example, 1, and the maximum number of the sub-channels included in the sidelink resource pool is configured to not exceed 20.

In an embodiment of the present disclosure, for the sub-carrier spacing of 15 khz, the value of N may be, for example, 44, the value of K may be, for example, 2, and the maximum number of the sub-channels included in the sidelink resource pool is configured to not exceed 44/2=22. For the sub-carrier spacing of 30 khz, the value of N may be, for example, 36, the value of K may be, for example, 2, and the maximum number of the sub-channels included in the sidelink resource pool is configured to not exceed 36/2=18. For the sub-carrier spacing of 60 khz, the value of N may be, for example, 22, the value of K may be, for example, 2, and the maximum number of the sub-channels included in the sidelink resource pool is configured to not exceed 22/2=11. For the sub-carrier spacing of 120 khz, the value of N may be, for example, 20, the value of K may be, for example, 2, and the maximum number of the sub-channels included in the sidelink resource pool is configured to not exceed 20/2=10.

According to the embodiments of the present disclosure, N and K are determined according to the sub-carrier spacing. It is determined that the K candidate starting symbols are supported in one slot in the sidelink resource pool. The maximum number of the sub-channels included in the sidelink resource pool is configured to not exceed the floor (N/K), where N and K are positive integers. In the embodiments of the present disclosure, a configuration mechanism for the resource pool may be provided, and the maximum number of the sub-channels included in the sidelink resource pool may be configured. Thus complexity of the blind detection by a receiving user equipment is reduced. Further, a situation that the receiving user equipment cannot receive data in a case that a number of the blind detections exceeds the maximum number of blind detections by the receiving user equipment is reduced. Consequently, the energy consumption of the receiving user equipment may be reduced. A solution to determine N and K according to sub-carrier spacing is disclosed in the embodiments of the present disclosure. The present disclosure provides a method for “configuring a resource pool”. The maximum number of the sub-channels included in the sidelink resource pool is configured to not exceed floor (N/K), such that the number of the sub-channels in the sidelink resource pool may be reduced, then the number of blind detections of the PSCCH by the receiving user equipment may be reduced, and the energy consumption of the receiving user equipment may be reduced.

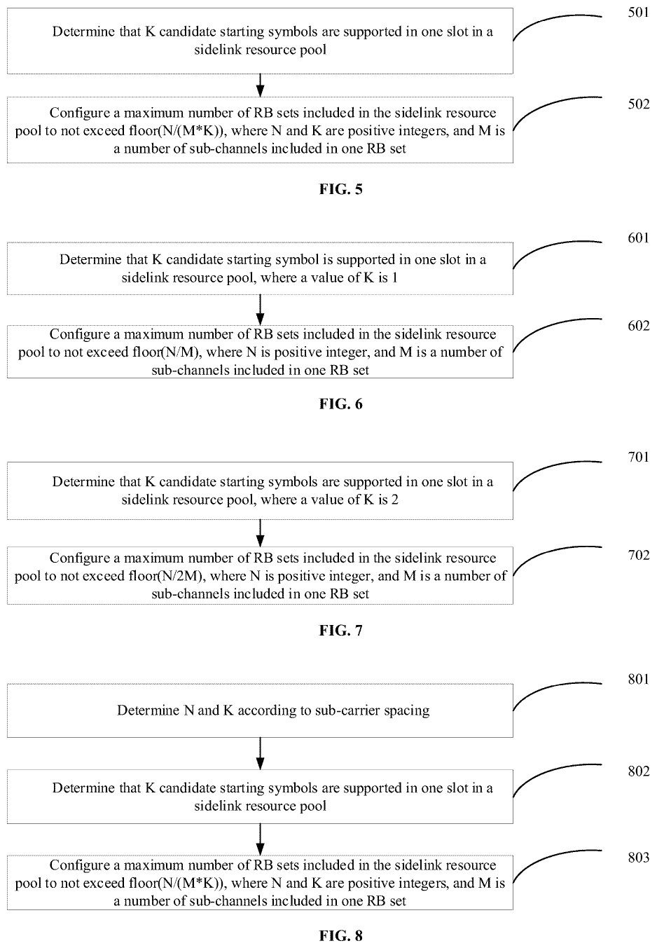

FIG. 5 is a schematic flowchart of a method for configuring a resource pool according to an embodiment of the present disclosure. The method is performed by a network device. As shown in FIG. 5, the method may include steps 501 to 502.

Step 501 includes determining that K candidate starting symbols are supported in one slot in a sidelink resource pool.

Step 502 includes configuring a maximum number of resource block (RB) sets included in the sidelink resource pool to not exceed floor (N/(M*K)), where N and K are positive integers, and M is a number of sub-channels included in one RB set.

In an embodiment of the present disclosure, the method is applied to an unlicensed frequency band of a sidelink.

In an embodiment of the present disclosure, floor indicates a round-down function. For example, the floor (N/(M*K)) may indicate a round-down function for N/(M*K). For example, the floor (N/K) may be a largest integer not greater than N/(M*K).

Furthermore, in an embodiment of the present disclosure, one candidate starting symbol is supported in one slot. The maximum number of RB sets does not exceed floor (N/M).

In an embodiment of the present disclosure, it is determined that one candidate starting symbol is supported in one slot in the sidelink resource pool. The maximum number of RB sets included in the sidelink resource pool is configured to not exceed the floor (N/M).

Furthermore, in an embodiment of the present disclosure, two candidate starting symbols are supported in one slot. The maximum number of RB sets does not exceed floor (N/2M).

In an embodiment of the present disclosure, it is determined that the two candidate starting symbols are supported in one slot in the sidelink resource pool. The maximum number of RB sets included in the sidelink resource pool is configured to not exceed the floor (N/2M).

In an embodiment of the present disclosure, N is a maximum number of blind detections of PSCCH supported by a user equipment in one slot.

Moreover, in an embodiment of the present disclosure, N is a maximum number of blind detections of PDCCH supported by the user equipment in one slot.

In an embodiment of the present disclosure, for sub-carrier spacing of 15 khz, the value of N may be, for example, 44. For sub-carrier spacing of 30 khz, the value of N may be, for example, 36. For sub-carrier spacing of 60 khz, the value of N may be, for example, 22. For a sub-carrier spacing of 120 khz, the value of N may be, for example, 20.

Further, in an embodiment of the present disclosure, the method further includes: determining N and K according to sub-carrier spacing.

In an embodiment of the present disclosure, in a case where the sub-carrier spacing is 15 khz, the value of N may be, for example, 44, and the value of K may be, for example, 1. In a case where one sub-channel is equal to two interlaces, a value of M may be, for example, 5. That is, the maximum number of the supported RB sets does not exceed 8, that is, floor (44/(1×5))=8. In a case where one sub-channel is equal to one interlace, the value of M may be, for example, 10. That is, the maximum number of the supported RB sets does not exceed 4, that is, floor (44/(1×10))=4.

In an embodiment of the present disclosure, in a case where the sub-carrier spacing is 15 khz, the value of N may be, for example, 44, and the value of K may be, for example, 2. In a case where one sub-channel is equal to two interlaces, the value of M may be, for example, 5. That is, the number of the supported RB sets does not exceed 4, that is, floor (44/(2×5))=4. In a case where one sub-channel is equal to one interlace, the value of M may be, for example, 10. That is, the number of the supported RB sets does not exceed 2, that is, floor (44/(2×10))=2.

In an embodiment of the present disclosure, in a case where the sub-carrier spacing is 30 khz, the value of N may be, for example, 36, and the value of K may be, for example, 1. In a case where one sub-channel is equal to two interlaces, the value of M may be, for example, 5. That is, the maximum number of supported RB sets does not exceed 7, that is, floor (36/(1×5))=7. In a case where one sub-channel is equal to one interlace, the value of M may be, for example, 5. That is, the maximum number of supported RB sets does not exceed 3, that is, floor (36/(1×10))=3.

In an embodiment of the present disclosure, in a case where the sub-carrier spacing is 30 khz, the value of N may be, for example, 36, and the value of K may be, for example, 2. In a case where one sub-channel is equal to two interlaces, the value of M may be, for example, 5. That is, the maximum number of supported RB sets does not exceed 3, that is, floor (36/(2×5))=3. In a case where one sub-channel is equal to one interlace, the value of M may be, for example, 10. That is, the maximum number of supported RB sets does not exceed 1, that is, floor (36/(2×10))=1.

According to the embodiments of the present disclosure, it is determined that the K candidate starting symbols are supported in one slot in the sidelink resource pool. The maximum number of RB sets included in the sidelink resource pool is configured to not exceed the floor (N/(M*K)). N and K are positive integers. M is a number of the sub-channels included in one RB set. In the embodiments of the present disclosure, a configuration mechanism for the resource pool may be provided, and the maximum number of RB sets included in the sidelink resource pool may be configured, such that the number of the sub-channels in the resource pool is limited. Thus complexity of the blind detection by a receiving user equipment is reduced. Further, a situation that the receiving user equipment cannot receive data in a case that a number of the blind detections exceeds the maximum number of blind detections by the receiving user equipment is reduced. Consequently, the energy consumption of the receiving user equipment may be reduced. The present disclosure provides a method for “configuring a resource pool”. The maximum number of RB sets included in the sidelink resource pool is configured to not exceed floor (N/(M*K)), such that the number of RB sets in the sidelink resource pool may be reduced. Thus the number of the sub-channels in the sidelink resource pool may be reduced, the number of the blind detections of the PSCCH by the receiving user equipment may be reduced, and the energy consumption of the receiving user equipment may be reduced.

FIG. 6 is a schematic flowchart of a method for configuring a resource pool according to an embodiment of the present disclosure. The method is performed by a network device. As shown in FIG. 6, the method may include steps 601 to 602.

Step 601 includes determining that K candidate starting symbol is supported in one slot in a sidelink resource pool, where a value of K is 1.

Step 602 includes configuring a maximum number of resource block (RB) sets included in the sidelink resource pool to not exceed floor (N/M), where N is a positive integer, and M is a number of sub-channels included in one RB set.

In an embodiment of the present disclosure, description of steps 601 to 602 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

Furthermore, in an embodiment of the present disclosure, one candidate starting symbol is supported in one slot. The maximum number of RB sets does not exceed the floor (N/M).

In an embodiment of the present disclosure, N is a maximum number of the blind detections of PSCCH supported by a user equipment in one slot.

Moreover, in an embodiment of the present disclosure, N is a maximum number of the blind detections of PDCCH supported by the user equipment in one slot.

In an embodiment of the present disclosure, a value of K may be, for example, 1. For example, a number of the candidate starting symbols supported in one slot may be one. M is a number of the sub-channels included in one RB set.

In an embodiment of the present disclosure, in a case where the sub-carrier spacing is 15 khz, the value of N may be, for example, 44, and the value of K may be, for example, 1. In a case where one sub-channel is equal to two interlaces, a value of M may be, for example, 5. That is, the maximum number of supported RB sets does not exceed 8, that is, floor (44/(1×5))=8. In a case where one sub-channel is equal to one interlace, the value of M may be, for example, 10. That is, the maximum number of supported RB sets does not exceed 4, that is, floor (44/(1×10))=4.

In an embodiment of the present disclosure, in a case where the sub-carrier spacing is 30 khz, the value of N may be, for example, 36, and the value of K may be, for example, 1. In a case where one sub-channel is equal to two interlaces, the value of M may be, for example, 5. That is, the maximum number of supported RB sets does not exceed 7, that is, floor (36/(1×5))=7. In a case where one sub-channel is equal to one interlace, the value of M may be, for example, 5. That is, the maximum number of supported RB sets does not exceed 3, that is, floor (36/(1×10))=3.

According to the embodiments of the present disclosure, it is determined that one candidate starting symbol is supported in one slot in the sidelink resource pool. The maximum number of RB sets included in the sidelink resource pool is configured to not exceed the floor (N/M). N is a positive integer. M is a number of the sub-channels included in one RB set. In the embodiments of the present disclosure, a configuration mechanism for the resource pool may be provided, and the maximum number of RB sets included in the sidelink resource pool may be configured, such that the number of the sub-channels in the resource pool is reduced. Thus complexity of blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. The embodiments of the present disclosure disclose a solution for configuring the maximum number of RB sets included in the sidelink resource pool in a case where the number of the candidate starting symbols supported in one slot is one. The present disclosure provides a method for “configuring a resource pool”. The maximum number of RB sets included in the sidelink resource pool is configured to not exceed floor (N/M), such that the number of RB sets in the sidelink resource pool can be reduced. Thus, the number of sub-channels in the sidelink resource pool may be reduced, the number of blind detections of the PSCCH by the receiving user equipment may be reduced, and the energy consumption of the receiving user equipment may be reduced.

FIG. 7 is a schematic flowchart of a method for configuring a resource pool according to an embodiment of the present disclosure. The method is performed by a network device. As shown in FIG. 7, the method may include steps 701 to 702.

Step 701 includes determining that K candidate starting symbols are supported in one slot in a sidelink resource pool, where a value of K is 2.

Step 702 includes configuring a maximum number of resource block (RB) sets included in the sidelink resource pool to not exceed floor (N/2M), where N is a positive integer, and M is a number of sub-channels included in one RB set.

In an embodiment of the present disclosure, description of steps 701 to 702 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

Furthermore, in an embodiment of the present disclosure, the two candidate starting symbols are supported in one slot. The maximum number of RB sets does not exceed floor (N/2M).

In an embodiment of the present disclosure, N is a maximum number of blind detections of PSCCH supported by a user equipment in one slot.

Moreover, in an embodiment of the present disclosure, N is a maximum number of the blind detections of PDCCH supported by the user equipment in ne slot.

In an embodiment of the present disclosure, a value of K may be, for example, 2. For example, a number of the candidate starting symbols supported in one slot may be two. M is a number of the sub-channels included in one RB set.

In an embodiment of the present disclosure, in a case where the sub-carrier spacing is 15 khz, the value of N may be, for example, 44, and the value of K may be, for example, 2. In a case where one sub-channel is equal to two interlaces, a value of M may be, for example, 5. That is, the number of supported RB sets does not exceed 4, that is, floor (44/(2×5))=4. In a case where one sub-channel is equal to one interlace, the value of M may be, for example, 10. That is, the number of the supported RB sets does not exceed 2, that is, floor (44/(2×10))=2.

In an embodiment of the present disclosure, in a case where the sub-carrier spacing is 30 khz, the value of N may be, for example, 36, and the value of K may be, for example, 2. In a case where one sub-channel is equal to two interlaces, a value of M may be, for example, 5. That is, the maximum number of the supported RB sets does not exceed 3, that is, floor (36/(2×5))=3. In a case where one sub-channel is equal to one interlace, the value of M may be, for example, 10. That is, the maximum number of supported RB sets does not exceed 1, that is, floor (36/(2×10))=1.

According to the embodiments of the present disclosure, it is determined that two candidate starting symbols are supported in one slot in the sidelink resource pool. The maximum number of RB sets included in the sidelink resource pool is configured to not exceed the floor (N/2M). N is a positive integer. M is a number of the sub-channels included in one RB set. In the embodiments of the present disclosure, a configuration mechanism for the resource pool may be provided, and the maximum number of RB sets included in the sidelink resource pool may be configured, such that the number of the sub-channels in the resource pool is limited. Thus complexity of the blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. The embodiments of the present disclosure disclose a solution for configuring the maximum number of RB sets included in the sidelink resource pool in a case where the number of the candidate starting symbols supported in one slot is two. The present disclosure provides a method for “configuring a resource pool”. The maximum number of RB sets included in the sidelink resource pool is configured to not exceed floor (N/2M), such that the number of RB sets in the sidelink resource pool may be reduced. Thus the number of sub-channels included in the resource pool may be reduced, the number of blind detections of the PSCCH by the receiving user equipment may be reduced, and the energy consumption of the receiving user equipment may be reduced.

FIG. 8 is a schematic flowchart of a method for configuring a resource pool according to an embodiment of the present disclosure. The method is performed by a network device. As shown in FIG. 8, the method may include steps 801 to 803.

Step 801 includes determining N and K according to sub-carrier spacing.

Step 802 includes determining that K candidate starting symbols are supported in one slot in a sidelink resource pool.

Step 803 includes configuring a maximum number of resource block (RB) sets included in the sidelink resource pool to not exceed floor (N/(M*K)), where N and K are positive integers, and M is a number of sub-channels included in one RB set.

In an embodiment of the present disclosure, description of steps 801 to 803 may be described with reference to the above embodiments, which is not limited in the embodiments of the present disclosure. Instances in the embodiments of the present disclosure may be combined arbitrarily. The embodiments of the present disclosure may be combined with steps of other embodiments and instances of other embodiments without contradiction.

In an embodiment of the present disclosure, N is a maximum number of the blind detections of PSCCH supported by a user equipment in one slot.

Moreover, in an embodiment of the present disclosure, N is a maximum number of blind detections of PDCCH supported by the user equipment in one slot.

In an embodiment of the present disclosure, M is a number of the sub-channels included in the RB set.

In an embodiment of the present disclosure, in a case where the sub-carrier spacing is 15 khz, the value of N may be, for example, 44, and the value of K may be, for example, 1. In a case where the sub-carrier spacing is 30 khz, the value of N may be, for example, 36, and the value of K may be, for example, 2.

According to the embodiments of the present disclosure, N and K are determined according to the sub-carrier spacing. It is determined that K candidate starting symbols are supported in one slot in the sidelink resource pool. The maximum number of RB sets included in the sidelink resource pool is configured to not exceed the floor (N/(M*K)). N and K are positive integers. M is a number of the sub-channels included in one RB set. In the embodiments of the present disclosure, a configuration mechanism for the resource pool may be provided, and the maximum number of RB sets included in the sidelink resource pool may be configured, such that the number of the sub-channels in the resource pool is reduced. Thus complexity of the blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. A solution to determine N and K according to sub-carrier spacing is disclosed in the embodiments of the present disclosure. The present disclosure provides a method for “configuring a resource pool”. The maximum number of RB sets included in the sidelink resource pool is configured to not exceed floor (N/(M*K)), such that the number of RB sets in the sidelink resource pool may be reduced. Thus the number of the sub-channels in the resource pool may be reduced, the number of blind detections of the PSCCH by the receiving user equipment may be reduced, and the energy consumption of the receiving user equipment may be reduced.

FIG. 9 is a schematic structural diagram of a network device 900 according to an embodiment of the present disclosure. The network device is applied to an unlicensed frequency band of a sidelink. As shown in FIG. 9, the network device 900 may include a processing module 901 configured to determine that K candidate starting symbols are supported in one slot in a sidelink resource pool; and configure a maximum number of sub-channels included in the sidelink resource pool to not exceed floor (N/K), where N and K are positive integers.

According to the embodiments of the present disclosure, the processing module determines that the K candidate starting symbols are supported in one slot in the sidelink resource pool and configures the maximum number of the sub-channels included in the sidelink resource pool to not exceed the floor (N/K). N and K are positive integers. In the embodiments of the present disclosure, a configuration mechanism for the resource pool may be provided, and the maximum number of the sub-channels included in the sidelink resource pool may be configured, such that the number of the sub-channels in the resource pool is limited. Thus complexity of the blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. The present disclosure provides a network device for “configuring a resource pool”. The maximum number of the sub-channels included in the sidelink resource pool is configured, such that the number of sub-channels in the sidelink resource pool may be reduced, then the number of the blind detections of the PSCCH by the receiving user equipment may be reduced, and the energy consumption of the receiving user equipment may be reduced.

In some examples, in an embodiment of the present disclosure, one candidate starting symbol is supported in one slot, and floor (N) is equal to N.

In some examples, in an embodiment of the present disclosure, two candidate starting symbols are supported in one slot. The maximum number of the sub-channels does not exceed floor (N/2).

In some examples, in an embodiment of the present disclosure, N is a maximum number of blind detections of physical sidelink control channel (PSCCH) supported by a user equipment in one slot.

In some examples, in an embodiment of the present disclosure, N is a maximum number of blind detections of physical downlink control channel (PDCCH) supported by the user equipment in one slot.

In some examples, in an embodiment of the present disclosure, the processing module 901 is further configured to determine N and K according to sub-carrier spacing.

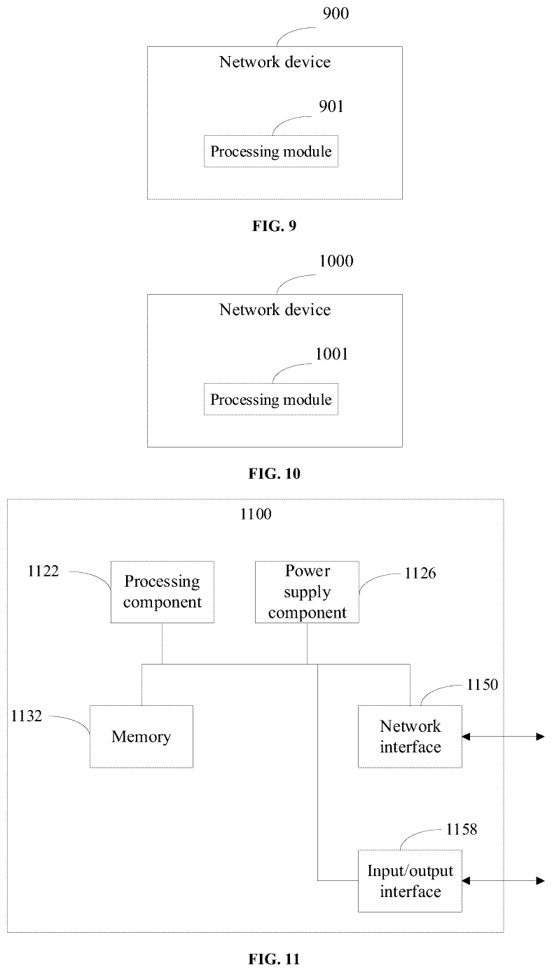

FIG. 10 is a schematic structural diagram of a network device 1000 according to an embodiment of the present disclosure. The network device is applied to an unlicensed frequency band of a sidelink. As shown in FIG. 10, the network device 1000 may include a processing module 1001 configured to determine that K candidate starting symbols are supported in one slot in a sidelink resource pool; and configure that a maximum number of resource block (RB) sets included in the sidelink resource pool does not exceed floor (N/(M*K)). N and K are positive integers. M is a number of sub-channels included in one RB set.

According to the embodiments of the present disclosure, the processing module determines that the K candidate starting symbols are supported in one slot in the sidelink resource pool, and configures the maximum number of RB sets included in the sidelink resource pool to not exceed the floor (N/(M*K)). N and K are positive integers. M is a number of the sub-channels included in one RB set. In the embodiments of the present disclosure, a configuration mechanism for the resource pool may be provided, and the maximum number of RB sets included in the sidelink resource pool may be configured, such that the number of the sub-channels in the resource pool is limited. Thus complexity of the blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. The present disclosure provides a network device for “configuring a resource pool”. The maximum number of RB sets included in the sidelink resource pool is configured to not exceed floor (N/(M*K)), such that the number of RB sets in the sidelink resource pool may be reduced. Thus the number of the sub-channels in the sidelink resource pool may be reduced, the number of blind detections of the PSCCH by the receiving user equipment may be reduced, and the energy consumption of the receiving user equipment may be reduced.

In some examples, in an embodiment of the present disclosure, one candidate starting symbol is supported in one slot. The maximum number of RB sets does not exceed floor (N/M).

In some examples, in an embodiment of the present disclosure, two candidate starting symbols are supported in one slot. The maximum number of RB sets does not exceed floor (N/2M).

In some examples, in an embodiment of the present disclosure, N is a maximum number of blind detections of PSCCH supported by a user equipment in one slot.

In some examples, in an embodiment of the present disclosure, N is a maximum number of blind detections of PDCCH supported by the user equipment in one slot.

In some examples, in an embodiment of the present disclosure, the processing module 1001 is further configured to determine N and K according to sub-carrier spacing.

FIG. 11 is a block diagram of a network device 1100 according to an embodiment of the present disclosure. For example, a network device 1100 may be provided as a network device. With reference to FIG. 11, the network device 1100 includes a processing component 1122, and further includes at least one processor and memory resources represented by a memory 1132 and configured to store instructions executable by the processing component 1122, for example, an application. The application stored in the memory 1132 may include one or more modules, each of which corresponds to a set of instructions. Further, the processing component 1122 is configured to perform the instructions to implement any of the methods described above as configured for the network device.

The network device 1100 may further include a power supply component 1126 configured to perform power component management of the network device 1100, a wired or wireless network interface 1150 configured to connect the network device 1100 to a network, and an input/output (I/O) interface 1158. The network device 1100 may operate based on an operating system stored in the memory 1132, such as Windows Server™, Mac OS X™, Unix™, Linux™, FreeBSD™, etc.

In the above embodiments provided by the present disclosure, the method provided in the embodiments of the present disclosure is introduced from the perspective of the network device and UE. In order to implement functions in the method provided in the above embodiments of the present disclosure, the network device and the UE may include a hardware structure and a software module. The above functions are implemented in a form of a hardware structure, a software module, or a hardware structure and a software module. Any one of the above functions may be executed by a hardware structure, a software module, or a hardware structure and a software module.

In the above embodiments provided by the present disclosure, the method provided in the embodiments of the present disclosure is introduced from the perspective of the network device and UE. In order to implement functions in the method provided in the above embodiments of the present disclosure, the network device and the UE may include a hardware structure and a software module. The above functions are implemented in a form of a hardware structure, a software module, or a hardware structure and a software module. Any one of the above functions may be executed by a hardware structure, a software module, or a hardware structure and a software module.

A communication device is provided in an embodiment of the present disclosure. The communication device may include a transceiving module and a processing module. The transceiving module may include a transmitting module and/or a receiving module. The transmitting module is configured to implement a transmitting function. The receiving module is configured to implement a receiving function. The transceiving module may implement the transmitting function and/or the receiving function.

The communication device may be a user equipment (such as the user equipment in the foregoing method embodiment), a device in the user equipment, or a device that can be used in conjunction with the user equipment. Alternatively, the communication device may be a network device, a device in a network device, or a device that can be used in conjunction with the network device.

Another communication device is provided in an embodiment of the present disclosure. The communication device may be a network device, may be a user equipment (such as the user equipment in the foregoing method embodiments), may be a chip, a chip system, or a processor that supports a network device to implement the above method, or may be a chip, a chip system, or a processor that supports a user equipment to implement the above method. The device may be configured to implement the methods described in the above method embodiments, and reference may be made to description in the above method examples for details.

The communication device may include one or more processors. The one or more processors may be a general purpose processor or a special purpose processor, etc., such as a baseband processor or a central processor. The baseband processor may be configured to process a communication protocol and communication data. The central processor may be configured to control a communication device (for example, a network device, a baseband chip, a user equipment, a user equipment chip, a DU or a CU), execute a computer program, and process data of the computer program.

In some examples, the communication device may further include one or more memories that may store a computer program. The one or more processors execute the computer program to cause the communication device to execute the method described in the above method embodiments. In some examples, the one or more memories may also store data. The communication device and the one or more memories may be arranged separately or may be integrated together.

In some examples, the communication device may further include a transceiver and an antenna. The transceiver may be referred to as a transceiving unit, a transceiving machine, a transceiving circuit, etc., and is configured to implement a transceiving function. The transceiver may include a receiver and a transmitter. The receiver may be referred to as a receiving machine or a receiving circuit, etc., for implementing a reception function. The transmitter may be referred to as a transmitting machine, a transmitting circuit, etc., for implementing a transmission function.

In some examples, the communication device may further include one or more interface circuits. The interface circuit is configured to receive a code instruction and transmitting the code instruction to the one or more processors. The one or more processors run the code instruction to cause the communication device to perform the method described in the above method embodiments.

The communication device is a network device. The processor is configured to perform the method shown in any one of FIG. 1 to FIG. 8.

In an implementation, the one or more processors may include a transceiver for implementing a reception function and a transmission function. For example, the transceiver may be a transceiving circuit, an interface, or an interface circuit. The transceiving circuit, interface, or interface circuit for implementing the reception function and the transmission function may be separated or integrated. The transceiving circuit, interface or interface circuit may be configured to read and write a code/data, and alternatively, the transceiving circuit, interface or interface circuit may be configured to transmit or transfer a signal.

In one implementation, the processor may store a computer program. The computer program runs on the one or more processors and causes the communication device to perform the method described in the method embodiments above. The computer program may be embedded in the one or more processors. In this case, the one or more processors may be implemented by hardware.

In an implementation, the communication device may include a circuit that may implement the functions of transmission, reception or communication in the foregoing method embodiments. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the above embodiment may be a network device or a user equipment (such as the user equipment in the foregoing method embodiments), but the scope of the communication device described in the present disclosure is not limited to this, and a structure of the communication device may not be limited. The communication device may be a stand-alone device or may be part of a large device. For example, the communication device may be:
(1) an independent integrated circuit (IC), a chip, a chip system or a subsystem; (2) a set of one or more ICs, in some examples including a memory component for storing data and a computer program; (3) an ASIC, such as a modem; (4) a module that can be embedded in other devices; (5) a receiver machine, a user equipment, an intelligent user equipment, a cellular phone, a radio device, a handset, a mobile unit, a vehicle-mounted device, a network device, a cloud device, an artificial intelligence device, etc.; and (6) other devices.

For a case where the communication device may be a chip or a chip system, the chip includes a processor and an interface. One or more processors may be provided. A plurality of interfaces may be provided.

In some examples, the chip further includes a memory. The memory is configured to store a necessary computer program and data.

Those skilled in the art will further appreciate that the various illustrative logical blocks and steps set forth in the embodiments of the present disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation is not to be understood to fall beyond the scope of protection of the embodiments of the present disclosure.

The present disclosure further provides a readable storage medium. The readable storage medium stores instructions. The instructions, when executed by a computer, implement the functions of any one of the method embodiments.

The present disclosure further provides a computer program product. The computer program product, when executed by a computer, implements the functions of the method embodiments.

The embodiments described above can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the embodiments of the present disclosure. The computer may be a general-purpose computer, a special-purpose computer, a computer network, or another programmable device. The computer program may be stored in a computer-readable storage medium or transmitted by one computer-readable storage medium to another computer-readable storage medium. For example, the computer program can be transmitted by one website, computer, server, or data center to another website, computer, server, or data center through a wired means (for example, a coaxial cable, an optical fiber, and a digital subscriber line (DSL)) or through a radio means (for example, infrared, radio waves, and microwaves). The computer-readable storage medium may be any available medium that can be accessed by a computer or a data storage device including one or more available media integrated server, a data center, etc. The available medium may be a magnetic medium (for example, a floppy disk, a hard disk, and a magnetic tape), an optical medium (for example, a digital video disk (DVD)), or a semiconductor medium (for example, a solid state disk (SSD)), etc.

By configuring that a maximum number of sub-channels included in a sidelink resource pool does not exceed floor (N/K) or a maximum number of resource block (RB) sets included in the sidelink resource pool does not exceed floor (N/(M*K)), the number of the sub-channels in the sidelink resource pool may be reduced, such that a number of blind detections of PSCCH by a receiving user equipment may be reduced, and then energy consumption of the receiving user equipment may be reduced.

According to the embodiments of the present disclosure, it is determined that the K candidate starting symbols are supported in one slot in the sidelink resource pool. The maximum number of the sub-channels included in the sidelink resource pool is configured to not exceed the floor (N/K), where N and K are positive integers. In the embodiments of the present disclosure, a configuration mechanism for the resource pool may be provided, and the maximum number of the sub-channels or the maximum number of RB sets included in the sidelink resource pool may be configured, such that the number of the sub-channels in the resource pool is reduced. Thus complexity of the blind detection by a receiving user equipment is reduced. Further, a situation that the receiving user equipment cannot receive data in a case that a number of blind detections exceeds the maximum number of blind detections by the receiving user equipment is reduced. Consequently, the energy consumption of the receiving user equipment may be reduced. The present disclosure provides a method for “configuring a resource pool”. The maximum number of the sub-channels or the maximum number of RB sets included in the sidelink resource pool is configured, such that the number of the sub-channels in the sidelink resource pool is reduced, then the number of blind detections of the PSCCH by the receiving user equipment may be reduced, and the energy consumption of the receiving user equipment may be reduced.

Those skilled in the art may understand that the first, second and other numerical numbers referred to in the present disclosure are merely for distinction for convenience of description, and are not intended to limit the scope of the embodiments of the present disclosure, and also represent the sequence.

At least one in the present disclosure may also be described as one or more, and plurality may be two, three, four, or more, which are not limited in the present disclosure. In the embodiments of the present disclosure, for a type of technical feature, technical features in such a type of technical feature are distinguished by “first,” “second,” “third,” “A,” “B,” “C” and “D,” and the technical features described by the “first,” “second,” “third,” “A,” “B,” “C” and “D” have no order of sequence or order of magnitude.

As used herein, the term “processor” may refer to one processor that performs the defined functions or a plurality of processors that collectively perform defined functions, such that the execution of the individual defined functions may be divided amongst such processors.

Those skilled in the art will readily conceive of other embodiments of the present disclosure after consideration of the description and practice of the invention disclosed in the present disclosure. The present disclosure is intended to cover any variations, uses, or adaptive changes of the present disclosure that follow the general principles of the present disclosure and include common general knowledge or customary technical means in the art not disclosed in the present disclosure. The description and the embodiments are merely deemed illustrative, and the true scope and spirit of the present disclosure are indicated by the following claims.

It is to be understood that the present disclosure is not limited to the precise structure that has been described above and shown in the accompanying drawings, and that various modifications and changes may be made without departing from the scope of the present disclosure. The scope of the present disclosure is limited merely by the appended claims.

1. A method for configuring a resource pool, applied to an unlicensed frequency band of a sidelink and performed by a network device, the method comprising:
determining that K candidate starting symbols are supported in one slot in a sidelink resource pool; and
configuring a maximum number of sub-channels comprised in the sidelink resource pool to not exceed floor (N/K), wherein N and K are positive integers.

2. The method according to claim 1, wherein one candidate starting symbol is supported in the slot, and floor (N) is equal to N.

3. The method according to claim 1, wherein two candidate starting symbols are supported in the slot, and the maximum number of the sub-channels does not exceed floor (N/2).

4. The method according to claim 1, wherein N is a maximum number of blind detections of physical sidelink control channel (PSCCH) supported by a user equipment in the one slot.

5. The method according to claim 1, wherein N is a maximum number of blind detections of physical downlink control channel (PDCCH) supported by a user equipment in the one slot.

6. The method according to claim 1, wherein the method further comprises:
determining N and K according to sub-carrier spacing.

7. A method for configuring a resource pool, applied to an unlicensed frequency band of a sidelink and performed by a network device, the method comprising:
determining that K candidate starting symbols are supported in one slot in a sidelink resource pool; and
configuring a maximum number of resource block (RB) sets comprised in the sidelink resource pool to not exceed floor (N/(M*K)), wherein N and K are positive integers, and M is a number of sub-channels comprised in one RB set.

8. The method according to claim 7, wherein one candidate starting symbol is supported in the slot, and the maximum number of the RB sets does not exceed floor (N/M).

9. The method according to claim 7, wherein two candidate starting symbols are supported in the slot, and the maximum number of the RB sets does not exceed floor (N/2M).

10. The method according to claim 7, wherein N is a maximum number of blind detections of physical sidelink control channel (PSCCH) supported by a user equipment in the one slot.

11. The method according to claim 7, wherein N is a maximum number of blind detections of physical downlink control channel (PDCCH) supported by a user equipment in the one slot.

12. The method according to claim 7, wherein the method further comprises:
determining N and K according to sub-carrier spacing.

13.-14. (canceled)

15. A communication device, comprising:
a memory storing a computer program, and one or more processors configured to execute the computer program, and when executing the computer program, causes the communication device to:
determine that K candidate starting symbols are supported in one slot in a sidelink resource pool; and
configure a maximum number of sub-channels comprised in the sidelink resource pool to not exceed floor (N/K), wherein N and K are positive integers.

16. A communication device, comprising:
one or more processors;
an interface circuit configured to receive code instructions and transmit the code instructions to the one or more processors, and
wherein the one or more processors, when running the code instructions, are collectively configured to perform the method according to claim 1.

17. A non-transitory computer-readable storage medium, configured to store instructions, wherein the instructions, when executed by one or more processors of a communication device, cause the communication device to perform the method according to claim 1.

18. A communication device, comprising:
a memory that stores a computer program; and
one or more processors collectively configured to execute the computer program, and when executing the computer program, the one or processors are collectively configured to cause the communication device to perform the method according to claim 7.

19. A communication device, comprising:
one or more processors; and
an interface circuit configured to receive code instructions and transmit the code instructions to the one or more processors, and
wherein the one or more processors, when running the code instructions, are collectively configured to perform the method according to claim 7.

20. A non-transitory computer-readable storage medium, configured to store instructions, wherein the instructions, when executed by one or more processors of a communication device, cause the communication device to perform the method according to claim 7.

21. The communication device according to claim 15, wherein the communication device is further configured to:
determine N and K according to sub-carrier spacing.

22. The communication device according to claim 18, wherein the communication device is further configured to:
determine N and K according to sub-carrier spacing.
